(19) United States
(12) Patent Application Publication
(10) Pub. No.: US 2026/0332188 A1
(43) Pub. Date: Oct. 22, 2026

(54) THREE-PHASE COUPLER AND A COMMUNICATION SYSTEM

(71) Applicant: Beyond Gravity Sweden AB, Göteborg (SE)

(72) Inventor: Mikael ÖHGREN, Öjersjö (SE)

(21) Appl. No.: 19/468,272

(22) Filed: Feb. 3, 2026

(30) Foreign Application Priority Data
Feb. 13, 2025 (EP) 25157725

(51) Int. Cl. H04B 3/56; H01P 5/22

(52) U.S. Cl. CPC H04B 3/56; H01P 5/22; H04B 2203/5466

(57) ABSTRACT

The present invention relates to a three-phase coupler for feeding a signal from an input port to a first output port, a second output port, and a third output port. The coupler includes: a first transmission line extending from the input port to a first node; a second transmission line extending from the first node to a second node; a third transmission line extending from the second node to a third node; a fourth transmission line extending from the third node to a fourth node; a fifth transmission line extending from the fourth node to the first node; a sixth transmission line extending from the second node to the first output port; a seventh transmission line extending from the third node to the second output port; and an eighth transmission line extending from the fourth node to the third output port.

### CROSS-REFERENCE TO RELATED APPLICATION

The present application for patent claims priority to European Patent Office Application Ser. No. EP25157725.0, entitled “A THREE-PHASE COUPLER AND A COMMUNICATION SYSTEM” filed on February 13, 2025, assigned to the assignee hereof, and expressly incorporated herein by reference.

### TECHNICAL FIELD

The present disclosure generally relates to the field of microwave couplers and more specifically to the field of three-phase couplers.

### BACKGROUND

A three-phase coupler splits an input signal into three equal parts, each with a phase difference of 120°. This phase shift is essential for generating circular polarization, where the electric field rotates in a circular manner. When integrated with a patch antenna, the three-phase coupler ensures that the signals fed to different ports on the patch have the required phase differences. This setup allows the antenna to radiate circularly polarized waves, which are beneficial for applications requiring consistent signal reception regardless of the antenna orientation, such as satellite communications and GPS system. In the field of transmitting and receiving antennas, it is a desire to be able to choose bandwidth dependent on application. It is especially important to have a robust broadband solution for antennas in space since flexibility is desired.

A problem with known three-phase couplers (TPC) is that they often exhibit extensive footprint due to an elaborated routing of transmission lines between the ports of the TPC. This makes the TPC cumbersome to integrate with a small patch antenna. This often requires extensive routing of the waveguides of the TPC with increased losses and reflections, and associated production costs.

It is therefore a need for a better design that allows efficient integration with a patch antenna.

There is also a need for a TPC that provides a dense circuit, which increases integration with other components.

### SUMMARY

An object of the present disclosure is to provide an improved three-phase coupler which seeks to mitigate, alleviate, or eliminate one or more of the above-identified deficiencies in the art and disadvantages singly or in any combination and to provide an improved coupler that maintains the frequency broadband performance.

This object is obtained by a three-phase coupler for feeding a signal from an input port to a first output port, a second output port, and a third output port. The coupler comprises a first transmission line extending from the input port to a first node, a second transmission line extending from the first node to a second node, a third transmission line extending from the second node to a third node. The coupler further comprises a fourth transmission line extending from the third node to a fourth node, a fifth transmission line extending from the fourth node to the first node, a sixth transmission line extending from the second node to the first output port, a seventh transmission line extending from the third node to the second output port, and an eighth transmission line extending from the fourth node to the third output port. Each transmission line has a characteristic impedance and electrical length such that a signal fed to the input port is coupled to the output ports with a phase-shift.

According to an aspect, the phase-shift between each of the first output port, the second output port and the third output port are 120°.

According to an aspect, the first transmission line has a characteristic impedance Z=50Ω and Θ=10°, the second transmission line has a characteristic impedance Z=90Ω and an electrical length Θ=90°, the third transmission line has a characteristic impedance Z=36.7Ω and an electrical length Θ=180°, the fourth transmission line has a characteristic impedance Z=32.6Ω and an electrical length Θ=180°, the fifth transmission line has a characteristic impedance Z=40.6Ω and an electrical length Θ=90°, the sixth transmission line has a characteristic impedance Z=50Ω and Θ=L°, the seventh transmission line has a characteristic impedance Z=50Ω and an electrical length Θ=L+60°, and the eighth transmission line has a characteristic impedance Z=50Ω and an electrical length Θ=L+120°.

According to an aspect, the electrical length L is 10°.

According to an aspect, the transmission lines are planar structures. For example, the transmission lines may be microstrip lines.

According to an aspect, the second transmission line, the third transmission line, the fourth transmission line, and the fifth transmission line are connected in a closed shape, and wherein at least one of the sixth transmission line, the seventh transmission line and the eighth transmission line extends inside the closed shape. This way a denser circuit is achieved.

According to an aspect, the first transmission line extends inside, or outside, the closed shape.

According to an aspect, the closed shape is an elliptical shape.

The object is also obtained by a communication system, comprising a three-phase coupler according to embodiments, a signal generating device with an output connected to the input port of the three-phase coupler, and an antenna connected to the first output port, the second output port and the third output port.

Further objects and advantages may be found in the detailed description.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is an electrical circuit drawing of a three-port coupler according to one embodiment of the present invention.

FIG. 2 is a schematic block diagram of a communication system according to one embodiment of the present invention.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms "a", "an" and "the" are intended to include the plural forms as well, unless the context clearly indicates otherwise.

In this disclosure the term ‘port’ should be interpreted as a specific point in a microwave circuit where signals can enter or exit. Often used for connecting other transmission lines or antenna structures.

Some of the example embodiments presented herein are directed towards a three-phase coupler. As part of the development of the example embodiments presented herein, a problem will first be identified and discussed. In satellite communication it is often preferred to use circular polarization of the EM signal that is transmitted from the satellite. Circular polarization reduces the sensitivity to the orientation of the transmitting and receiving antennas. This is particularly useful in space where the relative orientation of satellites can change. A three port 120° coupler (TPC) can be used to achieve circular polarization by creating a phase shift between two orthogonal components of the signal. However, the known TPC exhibits large footprint and this is cumbersome in a space application since the available space in a spacecraft is extremely limited and valuable.

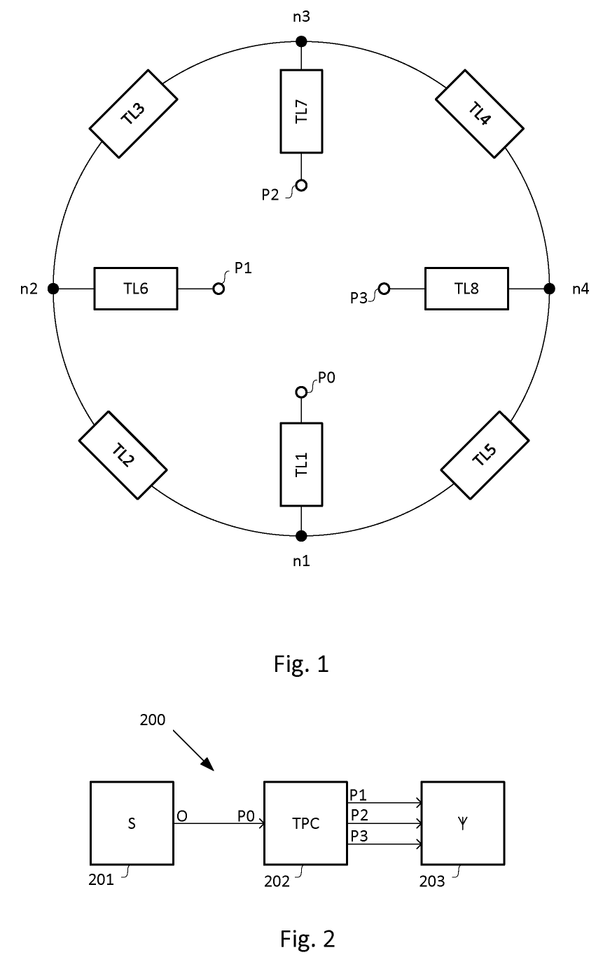

The present inventors realized that these problems may be minimized or even eliminated by a three-phase coupler, illustrated in FIG. 1, for feeding a signal from an input port P0 to a first output port P1, a second output port P2, and a third output port P3.

The coupler comprises:

A first transmission line TL1 extending from the input port P0 to a first node n1.

A second transmission line TL2 extending from the first node n1 to a second node n2.

A third transmission line TL3 extending from the second node n2 to a third node n3.

A fourth transmission line TL4 extending from the third node n3 to a fourth node n4.

A fifth transmission line TL5 extending from the fourth node n4 to the first node n1.

A sixth transmission line TL6 extending from the second node n2 to the first output port P1.

A seventh transmission line TL7 extending from the third node n3 to the second output port P2.

An eighth transmission line TL8 extending from the fourth node n4 to the third output port P3.

The transmission lines each have a characteristic impedance and electrical length such that a signal fed to the input port is coupled to the output ports P1,P2,P3 with a phase-shift.

Optionally, the phase-shift between each of the first output port P1, the second output port P2 and the third output port P3 are 120°.

Optionally, the first transmission line TL1 has a characteristic impedance Z=50Ω and an electrical length Θ=10°, the second transmission line TL2 has a characteristic impedance Z=90Ω and an electrical length Θ=90°, the third transmission line TL3 has a characteristic impedance Z=36.7Ω and an electrical length Θ=180°, the fourth transmission line TL4 has a characteristic impedance Z=32.6Ω and an electrical length Θ=180°, the fifth transmission line TL5 has a characteristic impedance Z=40.6Ω and an electrical length Θ=90°, the sixth transmission line TL6 has a characteristic impedance Z=50Ω and an electrical length Θ=L°, the seventh transmission line TL7 has a characteristic impedance Z=50Ω and an electrical length Θ=L+60°, the eighth transmission line TL8 has a characteristic impedance Z=50Ω and an electrical length Θ=L+120°.

Optionally, the electrical length L is 10°.

Optionally, the transmission lines TL1-TL8 are planar structures. Examples of planar structures are microstrip lines, coplanar waveguides, and strip lines.

Optionally, the second transmission line TL2, the third transmission line TL3, the fourth transmission line TL4, and the fifth transmission line TL5 are connected in a closed shape, and wherein at least one of the sixth transmission line TL6, the seventh transmission line TL7 and the eighth transmission line TL8 extends inside the closed shape.

Optionally, the first transmission line TL1 extends inside, or outside, the closed shape.

Optionally, the closed shape is an elliptical shape. Examples of elliptical shapes are circular, and oval.

Now with reference made to FIG. 2 in which a communication system, generally designated 200, is illustrated. The communication system comprises a three-phase coupler 202 according to any one of the preceding claims, a signal generating device 201 with an output O connected to the input port P0 of the three-phase coupler, and an antenna 203 connected to the first output port P1, the second output port P2 and the third output port P3 of the three-phase coupler 202.

The disclosure relates to a three-phase coupler for feeding a signal from an input port to a first output port, a second output port, and a third output port, wherein the coupler comprises: a first transmission line extending from the input port to a first node; a second transmission line extending from the first node to a second node; a third transmission line extending from the second node to a third node; a fourth transmission line extending from the third node to a fourth node; a fifth transmission line extending from the fourth node to the first node; a sixth transmission line extending from the second node to the first output port; a seventh transmission line extending from the third node to the second output port; an eighth transmission line extending from the fourth node to the third output port; wherein the transmission lines each having a characteristic impedance and length such that a signal fed to the input port is coupled to the output ports with a phase-shift.

According to some embodiments, the phase-shift between each of the first output port, the second output port and the third output port are 120°.

According to some embodiments, the first transmission line has a characteristic impedance Z=50Ω and an electrical length Θ=10°; the second transmission line has a characteristic impedance Z=90Ω and an electrical length Θ=90°; the third transmission line has a characteristic impedance Z=36.7Ω and an electrical length Θ=180°; the fourth transmission line has a characteristic impedance Z=32.6Ω and an electrical length Θ=180°; the fifth transmission line has a characteristic impedance Z=40.6Ω and an electrical length Θ=90°; the sixth transmission line has a characteristic impedance Z=50Ω and an electrical length Θ=L°; the seventh transmission line has a characteristic impedance Z=50Ω and an electrical length Θ=L+60°; the eighth transmission line has a characteristic impedance Z=50Ω and an electrical length Θ=L+120°.

According to some embodiments, the electrical length L is 10°.

According to some embodiments, the transmission lines are planar structures.

According to some embodiments, the second transmission line, the third transmission line, the fourth transmission line, and the fifth transmission line are connected in a closed shape, and wherein at least one of the sixth transmission line, the seventh transmission line and the eighth transmission line extends inside the closed shape.

According to some embodiments, the first transmission line extends inside, or outside, the closed shape.

According to some embodiments, the closed shape is an elliptical shape.

The disclosure also relates to a communication system, comprising a three-phase coupler according to any one of the preceding claims; a signal generating device with an output connected to the input port of the three-phase coupler; and an antenna connected to the first output port, the second output port and the third output port.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products.

It should be appreciated that the example embodiments presented herein may be practiced in any combination with each other. It should be noted that the word "comprising" does not necessarily exclude the presence of other elements or steps than those listed and the words "a" or "an" preceding an element do not exclude the presence of a plurality of such elements. It should further be noted that any reference signs do not limit the scope of the claims, that the example embodiments may be implemented at least in part by means of both hardware and software, and that several "means", "units" or "devices" may be represented by the same item of hardware.

1. A three-phase coupler for feeding a signal from an input port to a first output port, a second output port, and a third output port, wherein the coupler comprises:
a first transmission line extending from the input port to a first node;
a second transmission line extending from the first node to a second node;
a third transmission line extending from the second node to a third node;
a fourth transmission line extending from the third node to a fourth node;
a fifth transmission line extending from the fourth node to the first node;
a sixth transmission line extending from the second node to the first output port;
a seventh transmission line extending from the third node to the second output port;
an eighth transmission line extending from the fourth node to the third output port;
wherein the transmission lines each having a characteristic impedance and length such that a signal fed to the input port is coupled to the output ports with a phase-shift.

2. The three-phase coupler according to claim 1, wherein the phase-shift between each of the first output port, the second output port and the third output port are 120°.

3. The three-phase coupler according to claim 2, wherein:
the first transmission line has a characteristic impedance Z=50Ω and an electrical length Θ=10°;
the second transmission line has a characteristic impedance Z=90Ω and an electrical length Θ=90°;
the third transmission line has a characteristic impedance Z=36.7Ω and an electrical length Θ=180°;
the fourth transmission line has a characteristic impedance Z=32.6Ω and an electrical length Θ=180°;
the fifth transmission line has a characteristic impedance Z=40.6Ω and an electrical length Θ=90°;
the sixth transmission line has a characteristic impedance Z=50Ω and an electrical length Θ=L°;
the seventh transmission line has a characteristic impedance Z=50Ω and an electrical length Θ=L+60°;
the eighth transmission line has a characteristic impedance Z=50Ω and an electrical length Θ=L+120°.

4. The three-phase coupler according to claim 3, wherein the electrical length is 10°.

5. The three-phase coupler according to claim 1, wherein the transmission lines are a planar structure.

6. The three-phase coupler according to claim 5, wherein the second transmission line, the third transmission line, the fourth transmission line, and the fifth transmission line are connected in a closed shape, and wherein at least one of the sixth transmission line, the seventh transmission line and the eighth transmission line extends inside the closed shape.

7. The three-phase coupler according to claim 6, wherein the first transmission line extends inside, or outside, the closed shape.

8. The three-phase coupler according to claim 6, wherein the closed shape is an elliptical shape.

9. A communication system, comprising:
a three-phase coupler according to claim 1;
a signal generating device with an output connected to the input port of the three-phase coupler; and
an antenna connected to the first output port, the second output port and the third output port of the three-phase coupler.
